(19) United States
(12) Patent Application Publication
(10) Pub. No.: US 2015/0114789 A1
(43) Pub. Date: Apr. 30, 2015

(54) WET CLUTCH

(71) Applicant: Schaeffler Technologies GmbH & Co. KG, Herzogenaurach (DE)

(72) Inventors: Michael Kuehnle, Buehl (DE); Toros Guelluek, Lichtenau (DE)

(21) Appl. No.: 14/397,602

(22) PCT Filed: May 6, 2013
(86) PCT No.: PCT/EP2013/059322

§ 371 Date: Oct. 28, 2014

(30) Foreign Application Priority Data
May 22, 2012 (DE) 10 2012 208 518.1

(51) Int. Cl. F16D 13/72; F16D 13/74

(52) U.S. Cl. CPC F16D 13/72; F16D 13/74
USPC 192/70.12

(57) ABSTRACT

A wet clutch comprising a first plate carrier and a second plate carrier which have different diameters, as well as an oil bath in which the plate carriers are arranged concentrically and rotatable with respect to one another. Here, the first plate carrier includes on its circumference a deflection element, by means of which oil which is moving tangentially with respect to the first plate carrier is deflected radially in the direction of the second plate carrier.

### CROSS-REFERENCE TO RELATED APPLICATIONS

This application is the U.S. national stage application pursuant to 35 U.S.C. §371 of International Application No. PCT/EP2013/059322 filed on May 6, 2013, which application claims priority from German Patent Application No. DE 10 2012 208518.1 filed on May 22, 2012, which applications are incorporated herein by reference in their entireties.

### FIELD OF THE INVENTION

The invention relates to a wet clutch for use in a drivetrain of a motor vehicle. In particular, the invention relates to a wet clutch for bridging a hydrodynamic torque converter.

### BACKGROUND OF THE INVENTION

In a drivetrain of a motor vehicle, a drive motor is connected to a transmission by means of a clutch device. The clutch device comprises a hydrodynamic torque converter, which transmits a torque from the drive motor to the transmission as long as an input side and an output side of the torque converter have different speeds of rotation. Thus the torque converter is helpful in particular for starting up the motor vehicle. In order to minimize flow losses within the torque converter, a friction clutch may be used to connect the input side to the output side torsionally as soon as the rotational speed difference has fallen below a predetermined value, for example because the motor vehicle has been started up. In another embodiment, the transmission of torque from the drive motor to the transmission can also be achieved without a hydrodynamic converter, by means of the friction clutch alone.

The clutch is preferably a friction-disk clutch, which runs in a fluid bath, in particular in an oil bath. An outer plate carrier and an inner plate carrier, which have different diameters, are rotatably supported concentric to each other. At the same time, one of the plate carriers is connected to the input side and the other is connected to the output side of the clutch device. In the radial intermediate space between the plate carriers there is an axial stack of a plurality of plates. The individual plates are torsionally connected alternately to the inner and the outer plate carriers. If an axial force acts on the stack of plates, friction between the plates increases, so that torque can be transmitted between the input side and the output side.

If the friction-disk clutch is in the disengaged or partially disengaged state, the plate carriers can have different speeds of rotation. One of the plate carriers may be stationary relative to an external reference system, such as a housing, or may rotate only slowly. The oil surrounding the friction-plate clutch is accelerated in the circumferential direction by the more rapidly rotating plate carrier, and is driven radially outward under the influence of centrifugal force. This ensures a throughput of oil through this plate carrier for the purpose of cooling and lubrication. The oil, on a circular path, is slowed down however on the more slowly rotating plate carrier, so that the flow in the circumferential direction or in the radial direction may practically come to a standstill there. The second plate carrier may thus be subjected only to a flow of oil too weak to ensure cooling or lubrication.

### BRIEF SUMMARY OF THE INVENTION

A wet clutch according to the invention includes a first plate carrier and a second plate carrier which have different diameters, as well as an oil bath in which the plate carriers are arranged concentrically and rotatable relative to each other. At the same time, the first plate carrier includes on its circumference a deflection element, in order to deflect oil which is moving tangentially relative to the first plate carrier, radially in the direction of the second plate carrier.

A flow of oil to the second plate carrier can be ensured by the use of the deflection element. The deflection element is preferably attached to the plate carrier which rotates generally more rapidly than the other plate carrier relative to an external reference system such as a housing when the wet clutch is disengaged. In that respect, the first plate carrier may be connected in particular to an output shaft of a drive motor, and the second plate carrier may be connected to the input shaft of a transmission. At the same time, it may be unimportant whether the first plate carrier is the inner one and the second the outer one, or vice versa. In both cases, the deflection element may be used for an improved supply of oil to the respective other plate carrier.

In a preferred embodiment, the first plate carrier has a radial opening, to whose rear side in the direction of flow the deflection element is attached, the deflection element extending tangentially contrary to the direction of flow and radially away from the second plate carrier.

In this way, the deflection element can form a type of vane, against which the tangentially flowing oil streams and which deflects it into a radial direction, or at least utilizes a back pressure of the oil to convey part of the oil in the radial direction. The oil can pass through the opening and be conveyed further in the direction of the second plate carrier.

In an especially preferred embodiment, the plate carrier is producible from a metal sheet, and the deflection element can be produced by folding up the sheet on one side in the area of the opening. This enables a simple, cost-effective production of the first plate carrier, and thus of the wet clutch.

In a variant of the invention, the first plate carrier has radial toothing for torsional connection to a plate, the deflection element being located in the area of the toothing. At the same time, the toothing may also be used to bring about the radial flow of oil by means of the deflection element.

In particular, the deflection element may be formed by a tooth flank of the toothing. In this way, the design element of the toothing can serve an additional purpose. Complexity of the wet clutch may thus be increased only slightly, or not at all, by the deflection element.

In an especially preferred embodiment, the tooth flange extends tangentially contrary to the direction of flow and radially away from the second plate carrier, which introduces an opening for the flow of oil into the tooth flange. The oil can thus pass through the plate carrier in the tangential direction at a bearing tooth flank, at which the torque of the plate carrier is transferred to a plate. The tooth flank can thereby be better penetrated by a flow of oil in a highly loaded region, and thus be protected from excessive temperature and increased wear.

In one embodiment, the opening is located at a radius of the toothing which faces radially away from the second plate carrier. Stated differently, the opening can be located at a base circle of the toothing, if the first plate carrier is the inner plate carrier, and at an outside circle of the toothing if the first plate carrier is the outer plate carrier. Variants are also possible, however, in which the opening is located at the radius of the toothing which faces radially toward the second plate carrier.

The toothing may comprise a plurality of tooth flanks, which extend radially at different distances from the second plate carrier. For example, each second, third or generally nth (where n≧2) tooth flange of the toothing in the circumferential direction can extend further in the radial direction than the other tooth flanks. The other tooth flanks can thus represent a relatively small obstacle for oil flowing in the circumferential direction, while the longer tooth flank is better able to function as a deflection element.

Furthermore, the wet clutch may include a plate, where the plate has toothing which corresponds to the toothing of the first plate carrier, and where the toothing of the plate has a radial cutout in the area of the opening. The teeth of the toothing of the plate may also be sufficiently short in the radial direction that they do not impede flow in the area of the opening. This will improve the transporting effect of the deflection element.

In particular, the radial cutout may have a trapezoidal or triangular cross section between the toothing of the plate and the toothing of the first plate carrier in the area of the opening.

It is therefore the object of the invention to prepare a wet clutch whose plate carriers are adequately washed by the fluid surrounding them under all operating conditions. The invention fulfills this object by means of a wet clutch having the features of the independent claim. Subordinate claims describe preferred embodiments.

### BRIEF DESCRIPTION OF THE DRAWINGS

The invention will now be described in greater detail by reference to the accompanying figures, in which the figures represent the following:

FIG. 1 is a schematic depiction of a wet clutch;

FIG. 2 is a detail of one of the wet clutches from FIG. 1 in a first embodiment; and,

FIGS. 3 to 8 illustrate details from FIG. 2 in additional embodiments.

### DETAILED DESCRIPTION OF THE INVENTION

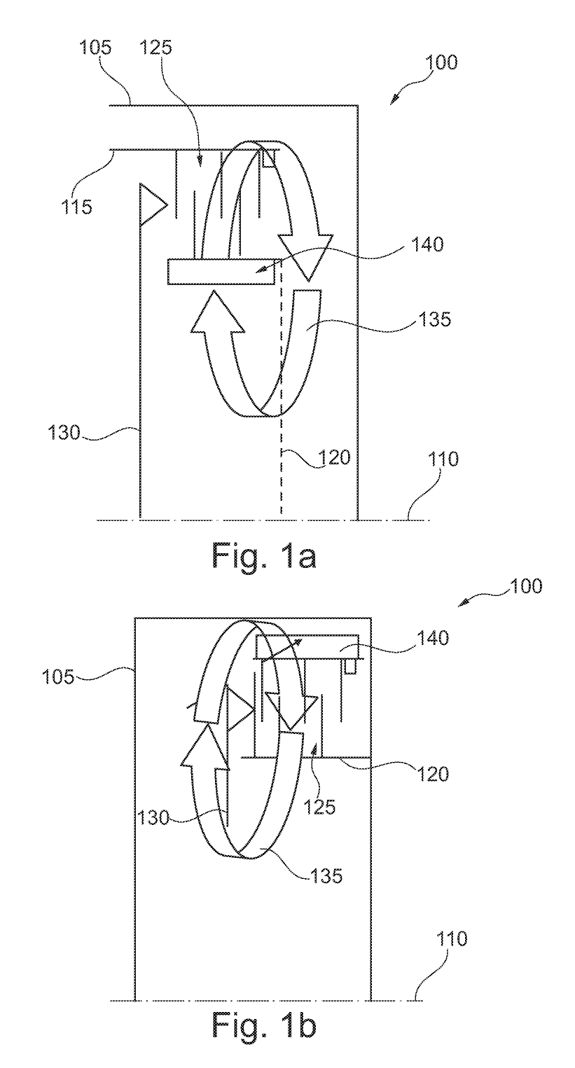

FIG. 1A shows a first schematic depiction of wet clutch 100. In housing 105, radially outer plate carrier 115 and radially inner plate carrier 120 are positioned rotatably around axis of rotation 110. Inner plate carrier 120 has a smaller radius than outer plate carrier 115. One of the plate carriers 115, 120 serves as the input side, the other as the output side of wet clutch 100.

In the radial gap between inner plate carrier 120 and outer plate carrier 115 are a number of ring-shaped plates 125, arranged in an axial stack. Within the stack, one of plates 125 is torsionally connected to outer plate carrier 115, and axially adjacent plate 125 is torsionally connected to inner plate carrier 120.

Engaging element 130, for example in the form of a hydraulic piston or a spring element, is provided in order to press the stack of plates 125 together in the axial direction when necessary. As this occurs, a frictional force between plates 125 increases, so that an increased torque can be transmitted between outer plate carrier 115 and inner plate carrier 120.

Wet clutch 100 runs in oil bath 135, which is at least partially subjected to a flow, which is represented by arrows. At a radially outer region of inner plate carrier 120 is deflection element 140, in order to deflect oil which is flowing tangentially along inner plate carrier 120 in the radial direction and to accelerate it in the direction of outer plate carrier 115.

The depiction in 1B shows a different embodiment of wet clutch 100 from FIG. 1A. Here, deflection element 140 is attached to outer plate carrier 115, and is designed so that the flow of oil of oil bath 135, which grazes a surface area of outer plate carrier 115, is deflected radially inward to inner plate carrier 120. In the depicted embodiment, inner plate carrier 120 is connected to housing 105 or is integrated with it.

Deflection element 140 can thus be employed optionally on inner plate carrier 120 or on outer plate carrier 115, in order to deflect tangentially flowing oil in each case in the direct on of the other plate carrier 115 or 120, respectively.

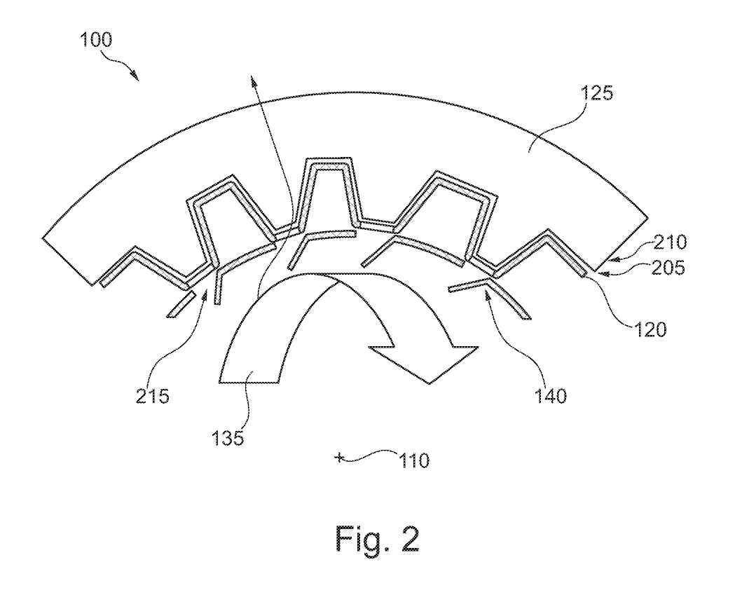

With reference to FIGS. 2 through 8, in the following section various embodiments of friction clutch 100 will be presented in greater detail, starting purely by way of example from inner plate carrier 120, whose deflection elements 140 deflect the oil radially outward. In a corresponding manner, the features which are shown and described may also be used however to provide deflection element 140 on outer plate carrier 115, in order to deflect the oil, which is flowing by tangentially, radially inward to inner plate carrier 120.

FIG. 2 shows a detail of one of wet clutches 100 from FIG. 1 in a first embodiment. The depiction is made as a sectional view perpendicular to axis of rotation 110.

Inner plate carrier 120 has toothing 205, which is engaged torsionally by toothing 210 of radially outer subsequent plate 125. The individual teeth of toothings 205 and 210 are trapezoid-shaped. In the base circle of toothing 205 there are radial openings 215 between the teeth of toothing 205, in order to allow a stream of oil of oil bath 135 in the radial direction.

Deflection element 140 is attached to a rear end of each opening 215 in the direction of flow. This deflection element extends radially inward and tangentially contrary to the direction of flow of the oil of oil bath 135. In a different embodiment than the one depicted, this section of deflection element 140 which extends radially outward may also be, for example, of an S-shaped or Z-shaped design instead of a straight one. In the depicted embodiment, an optional tangential appendage is provided on each of deflection elements 140, in order to seal a tooth of toothing 205 of inner plate carrier 120 against the oil of oil bath 135, and thus to reduce a flow resistance of inner plate carrier 120.

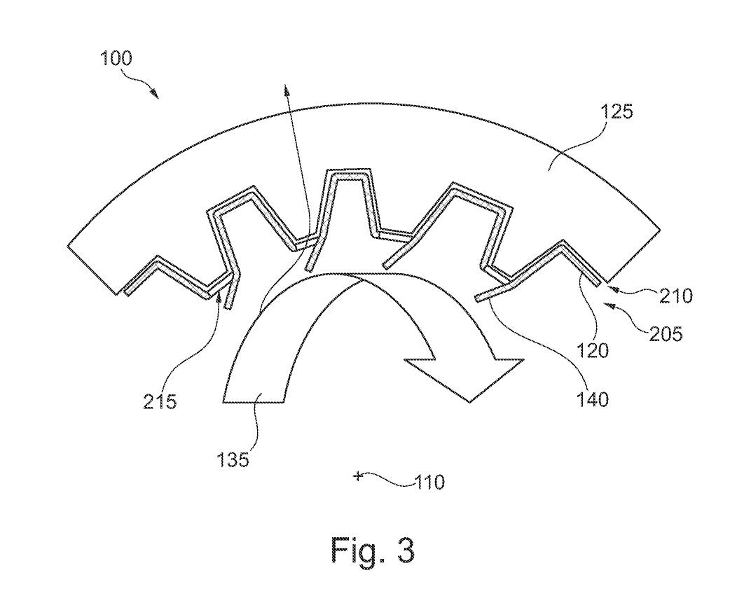

FIG. 3 shows a variation of the embodiment shown in FIG. 2. Openings 215 and deflection elements 140 are located at the same positions as in the embodiment shown in FIG. 2, but deflection elements 140 are integrated with inner plate carrier 120, in that deflection elements 140 are unfolded or bent out from the sheet metal material of inner plate carrier 120 on one side. This can be achieved, for example, by means of a stamping and bending process.

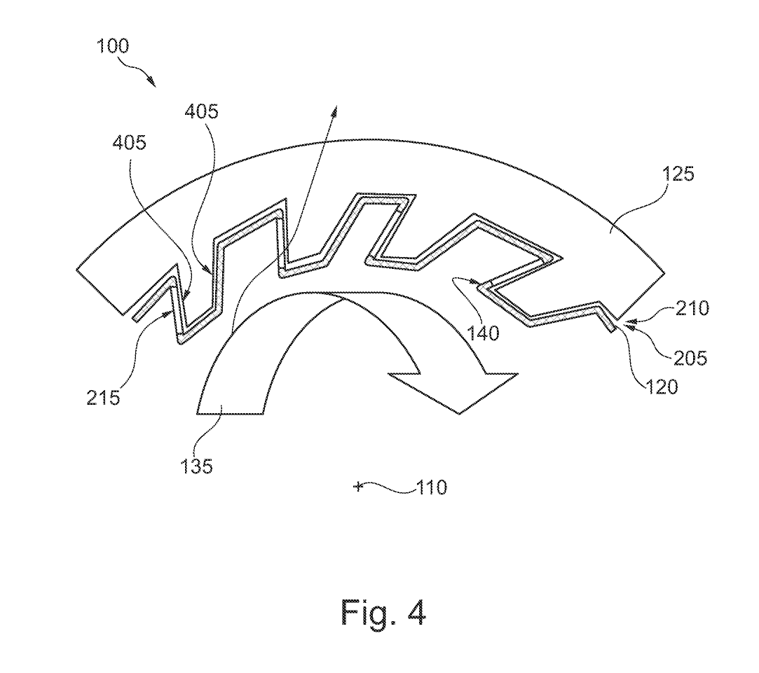

FIG. 4 shows another embodiment of wet clutch 100, corresponding to the depictions of FIGS. 2 and 3. Here, toothings 205 and 210 of inner plate carrier 120 or of plate 125 which correspond to each other are designed so that tooth flank 405 extends from oil bath 135 in the radial direction contrary to the direction of flow of the oil. Preferably this is bearing tooth flank 405; that is, in reference to FIG. 4, either inner plate carrier 120 drives plate 125 in the clockwise direction, or plate 125 drives inner plate carrier 120 counter-clockwise. Opening 215 is introduced here into tooth flank 405 which is inclined contrary to the direction of flow. An opposing tooth flank 405 extends in the radial direction, and in various embodiments may be inclined in or contrary to the direction of flow of the oil from oil bath 135 in the circumferential direction. The tooth of toothing 205, 210 formed by adjacent tooth flanks 405 can thereby assume a trapezoidal or rectangular form in cross section.

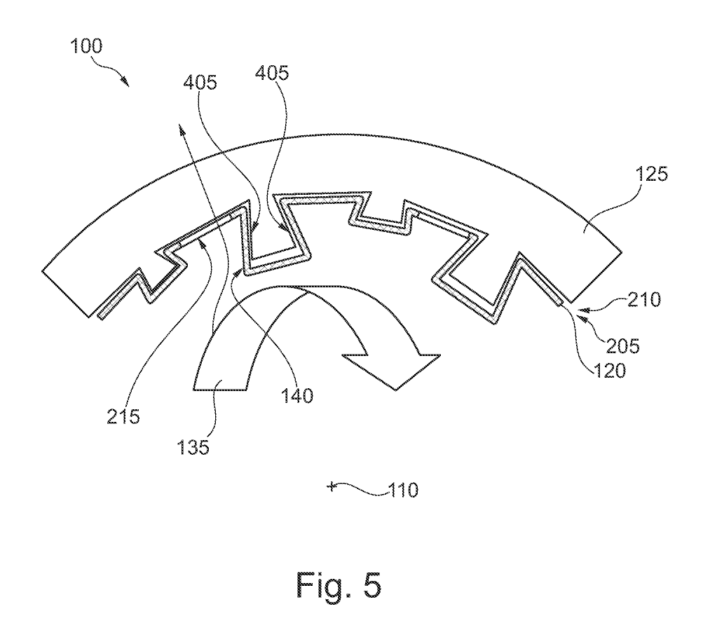

FIG. 5 shows another embodiment of wet clutch 100, corresponding to the depictions of FIGS. 2 through 4. Here, the teeth of toothings 205, 210 have the described trapezoidal form, where the spacing of adjacent tooth flanks 405 of a tooth decreases with increasing radius. Tooth flank 405 inclined contrary to the direction of flow of the oil from oil bath 135 again fulfills the function of deflection element 140. Opening 215 is located in the area of the outside circle of toothing 205 of inner plate carrier 120, or in the area of the base circle of toothing 210 of plate 125, and forms a passageway for the oil in the radial direction.

In the embodiment depicted in FIG. 5, teeth of toothings 205, 210 are alternately of different heights in the radial direction. In other embodiments, in general every nth (where n≧2) tooth of toothings 205, 210 is longer or shorter than the other teeth.

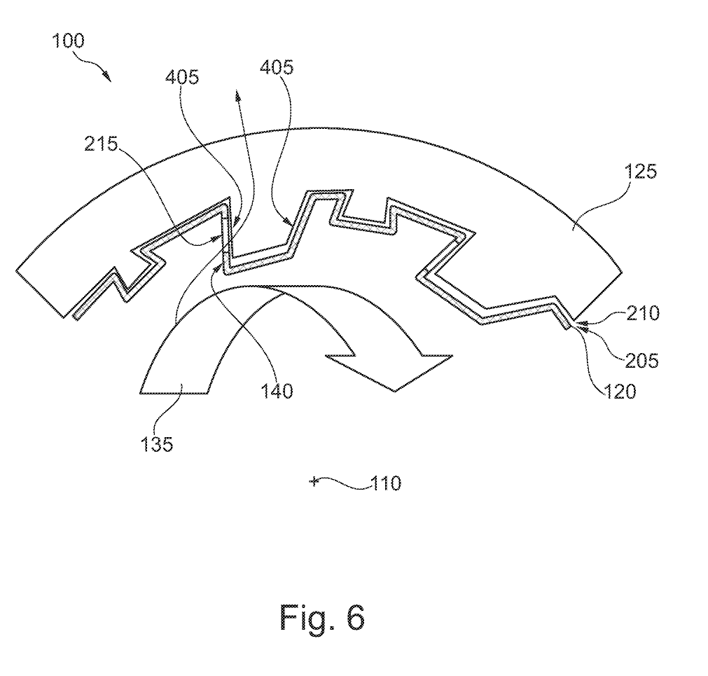

FIG. 6 shows another embodiment of wet clutch 100, corresponding to the depictions of FIGS. 2 through 5. Contrary to the embodiment shown in FIG. 5, openings 215 are again located in tooth flanks 405 of toothings 205, 210, inclined contrary to the direction of flow of the oil from oil bath 135. Here, openings 205 are introduced only on tooth flanks 405 of the teeth of toothings 205, 210 which are elongated in the radial direction. Tooth flank 405, which is located opposite tooth flank 405 having opening 215 on the radially elongated tooth, is inclined relative to a radius to axis of rotation 110 in the same direction as tooth flank 405 having opening 215. The tooth delimited by the two tooth flanks 405 thus has a trapezoidal form, with the width of the tooth increasing in the circumferential direction with increasing radius.

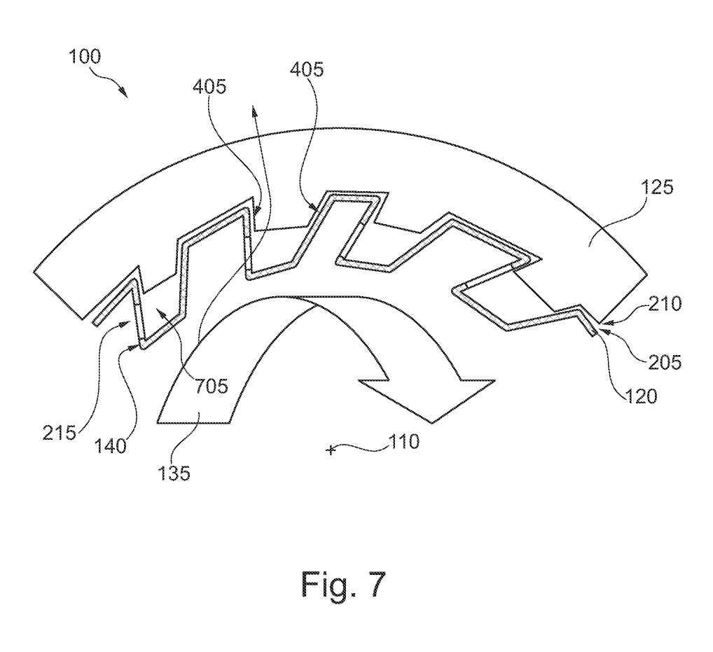

FIG. 7 shows a detail corresponding to FIGS. 2 through 6 of another embodiment of wet clutch 100. Here, toothings 205, 210 are distinguished corresponding to the radially elongated teeth of the embodiment shown in FIG. 6. In this case, an alternating radial length of the teeth has been dispensed with; however, the teeth have alternating different widths in the circumferential direction. In the area of opening 215, radial cutout 705 is introduced into toothing 210 of plate 125, so that the tooth of toothing 210 of plate 125 effectively extends less in the radial direction than toothing 205 of inner plate carrier 120 would allow. Cutout 705, or the free remaining space between toothings 205 and 210, has a trapezoidal shape. In the depicted embodiment, the trapezoid opens with increasing radius from axis of rotation 110; an opposite design is likewise possible.

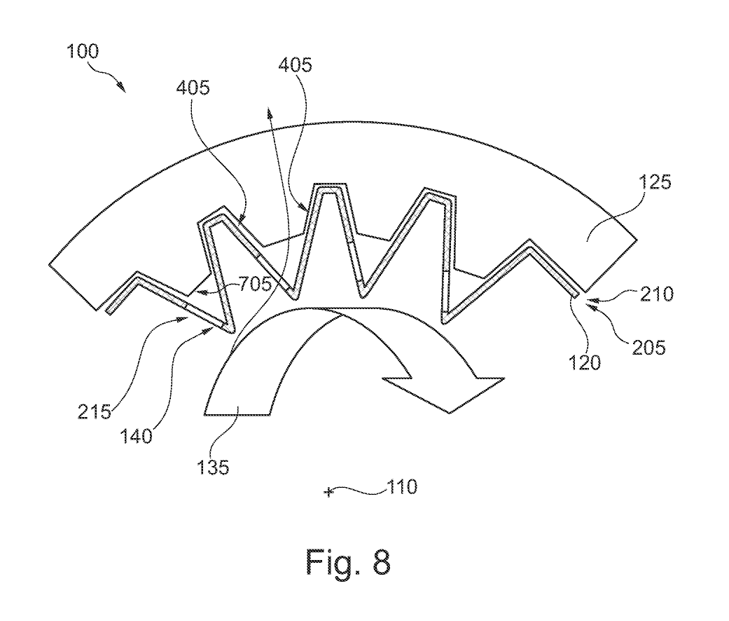

FIG. 8 shows another embodiment of wet clutch 100, corresponding to the depiction of FIGS. 2 through 7. In particular, a variant of the embodiment shown in FIG. 7 is depicted. Here, cutouts 705, or a free-remaining space between toothing 210 of the plate 125 and toothing 205 of inner plate carrier 120, have a triangular form on each tooth.

The different features of the embodiments shown in FIGS. 2 through 8 or described above are freely combinable with each other. In particular, the forms of the teeth of toothings 205, 210 have their alternating or cyclically recurring radial lengths and tangential widths; differently shaped cutouts 705 and the inclinations of tooth flanks 405 can be freely combined with each other. It is crucial here that deflection element 140 exists, which is set up to deflect oil of oil bath 135 from a tangential direction of motion into a radial direction to outer plate carrier 115.

As described already at the beginning, the features depicted or described may also be employed on outer plate carrier 115 instead of on inner plate carrier 120. The radial relationships are exchanged here, in that a deflection of the oil from oil bath 135 in the direction of the inner plate carrier 120 takes place radially toward the inside, instead of radially toward the outside, as described above.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMBERS

FIG. 1 schematic depiction of a wet clutch
FIG. 2 a detail of one of the wet clutches from FIG. 1 in a first embodiment
FIGS. 3-8 the detail from FIG. 2 in additional embodiments
100 Wet clutch
105 Housing
110 Axis of rotation
115 Outer plate carrier
120 Inner plate carrier
125 Plate
130 Engaging element
135 Oil bath
140 Deflection element
205 Toothing of the plate carrier
210 Toothing of the plate
215 Opening
405 Tooth flank
705 Cutout

What is claimed is:

1-10. (canceled)

11. A wet clutch (100), comprising:
a first plate carrier (115) and a second plate carrier (120), which have different diameters;
an oil bath (135), in which the plate carriers (115, 120) are positioned concentrically and rotatable relative to each other;
wherein the first plate carrier (120) includes on its circumference a deflection element (140), in order to deflect oil which is moving tangentially relative to the first plate carrier (120) radially in the direction of the second plate carrier (120).

12. The wet clutch (100) recited in claim 11, wherein the first plate carrier (120) has a radial opening (215), to whose rear side in the direction of flow the deflection element (140) is attached, and the deflection element (140) extends tangentially contrary to the direction of flow and radially away from the second plate carrier (120).

13. The wet clutch (100) recited in claim 12, wherein the first plate carrier (120) can be produced from a metal sheet, and the deflection element (140) is producible by folding the sheet up on one side in the area of the opening (215).

14. The wet clutch (100) recited in claim 11, wherein the first plate carrier (120) has radial toothing (205) for torsional connection to a plate (125), and the deflection element (140) is situated in the area of the toothing (205).

15. The wet clutch (100) recited in claim 14, wherein the deflection element (140) is formed by a tooth flank (405) of the toothing (205).

16. The wet clutch (100) recited in claim 15, wherein the tooth flank (405) extends tangentially contrary to the direction of flow and radially away from the second plate carrier (120), and an opening (215) for the passage of oil is introduced into the tooth flank (405).

17. The wet clutch (100) recited in claim 14, wherein the opening (215) is located at a radius of the toothing (205) which faces radially away from the second plate carrier (120).

18. The wet clutch (100) recited in claim 14, wherein the toothing (205) comprises a plurality of tooth flanks (405) which extend radially different distances away from the second plate carrier (120).

19. The wet clutch (100) recited in claim 14, additionally including a plate (125), wherein the plate includes corresponding toothing (210) which has a radial cutout (705) in the area of the opening.

20. The wet clutch (100) recited in claim 19, wherein the radial cutout (705) has a trapezoidal or triangular cross section between the toothing (210) of the plate (125) and the toothing (205) of the first plate carrier (120) in the area of the opening (215).
